(19) United States
(12) Patent Application Publication
(10) Pub. No.: US 2012/0185451 A1
(43) Pub. Date: Jul. 19, 2012

(54) DATA PROCESSING METHOD AND SYSTEM FOR DATABASE MANAGEMENT SYSTEM

(75) Inventor: Hee Jeong CHO, Gwangju-si (KR)

(73) Assignee: Samsung Electronics Co. Ltd., Suwon-si (KR)

(21) Appl. No.: 13/349,013

(22) Filed: Jan. 12, 2012

(30) Foreign Application Priority Data
Jan. 13, 2011 (KR) 10-2011-0003530

(51) Int. Cl. G06F 7/00

(52) U.S. Cl. 707/703; 707/E17.005

(57) ABSTRACT

A data processing method and system for a database management system are provided. The database management system can reduce the number of log records to be processed and increase database processing speed by selectively assigning a “no log” attribute to a data table at the time of database creation and skipping log recording for data items having the “no log” attribute at the time of database processing. The data processing method includes identifying one or more attributes assigned to a column of a data table associated with a data item changed during processing of a transaction, writing, when the one or more attributes of the column include a “log” attribute, log records for the transaction to a disk, and skipping, when the one or more attributes of the column include a “no log” attribute, log recording for the transaction.

### PRIORITY

This application claims the benefit under 35 U.S.C. §119(a) of a Korean patent application filed on Jan. 13, 2011 in the Korean Intellectual Property Office and assigned Serial No. 10-2011-0003530, the entire disclosure of which is hereby incorporated by reference.

### BACKGROUND OF THE INVENTION

1. Field of the Invention

The present invention relates to data processing in a DataBase Management System (DBMS). More particularly, the present invention relates to a data processing method and system that can reduce the number of log records to be processed and increase database processing speed in a database management system by selectively assigning a “no log” attribute to a data table at the time of database creation and skipping log recording for data items having the “no log” attribute at the time of database processing.

2. Description of the Related Art

A database may refer to a set of various data collected in an information processing system of an organization. For a database to assist in making decisions, it should be possible to easily access, process and update data values in the database. In other words, the database has to be capable of accepting a query for ad hoc retrieval or update, processing the query in real time, and producing results. The database has to maintain the most recent and accurate data through data manipulation operations such as insertion, deletion and update. The database should also be capable of being shared by multiple applications.

A DBMS is a software system that manages a database so that the database can be shared by multiple applications. The DBMS enables users to utilize data even though the users do not know the location of the data, and ensures the integrity and security of the data when handling user requests.

Such a DBMS uses a log to record processed transactions composed of data manipulation operations such as insertion, deletion, update or retrieval operations, expressed in a Data Manipulation Language (DML). As transactions are processed, the volume of the log or the number of log records increases and the number of input/output operations due to log recording increases accordingly. That is, log recording may increase the data processing time. Hence, it is necessary to shorten the data processing time by reducing the number of log entries generated in transaction processing.

Here, the transaction is a logical unit of database processing that includes one or more database access operations such as insertion, deletion, modification and retrieval. When a transaction starts and terminates, it may be either committed to the database (commit) or aborted (rollback). For example, a transaction may be composed of an insert statement, an update statement and a delete statement. When the transaction is ended successfully without any failure, the changes induced by the transaction may be actually reflected in the corresponding database (commit). When the transaction is ended unsuccessfully due to any failure, the changes or effects induced by the transaction must be undone (rollback).

### SUMMARY OF THE INVENTION

Aspects of the present invention are to address at least the above-mentioned problems and/or disadvantages and to provide at least the advantages described below. Accordingly, an aspect of the present invention provides a method and system that can increase the data processing speed of a database management system.

Another aspect of the present invention is to provide a data processing method and system that can increase the data processing speed of a database management system by selectively skipping log recording in transaction processing to reduce the number of input/output operations for logging.

Another aspect of the present invention is to provide a data processing method and system that can reduce the number of log records to be processed and increase database processing speed in a database management system by assigning a “log” attribute and a “no log” attribute to individual fields of a data table and skipping log recording for field values having the “no log” attribute.

In accordance with an aspect of the present invention, a method for data processing in a database management system is provided. The method includes identifying one or more attributes assigned to a column of a data table associated with a data item changed during processing of a transaction, writing, when the one or more attributes of the column include a “log” attribute, log records for the transaction to a disk, and skipping, when the one or more attributes of the column include a “no log” attribute, log recording for the transaction.

In an exemplary implementation, a “log” attribute or a “no log” attribute is selectively assigned to a column of a data table during database creation. Later, in the event of a transaction such as retrieval, insertion, deletion or update operations, log records for data items of a column of the data table having the “log” attribute are written and log recording for data items of a column having the “no log” attribute is skipped.

In accordance with another aspect of the present invention, computer readable storage media that contain computer programs implementing the above method are provided.

In accordance with another aspect of the present invention, a data processing system is provided. The system includes a Random Access Memory (RAM) for temporarily storing various programs and related data, a disk for storing data processed or to be processed, and for storing transaction logs, and a Database Management System (DBMS) for selectively assigning a “log” attribute or a “no log” attribute to a column of a data table, and for performing or for skipping log recording according to the “log” attribute or the “no log” attribute assigned to a column of a given data table during transaction processing.

In an exemplary implementation of the present invention, the data processing method enables a DBMS to assign a “log” attribute and a “no log” attribute to individual fields of a data table at the time of database creation. Later, the DBMS may skip log recording for field values having the “no log” attribute during transaction processing. Hence, the DBMS may reduce the number of log records to be processed, reduce the number of input/output operations for logging, and increase database processing speed. In addition, the number of log records to be processed during database recovery from an aborted transaction may be reduced. Hence, database recovery time may be shortened.

An exemplary data processing method and system of the present invention may be applied to real-time data processing applications. The advantageous effects of the increased database processing speed may become more prominent with increasing amounts of data. The method and system may be applied to various applications such as electronic billing, location-based services, external banking interfaces, stock quotation systems, contract settlement, and the like. The method and system may be highly compatible with existing systems.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a relationship between a DataBase Management System (DBMS) and a database according to an exemplary embodiment of the present invention;

FIG. 2 is a block diagram of a device according to an exemplary embodiment of the present invention;

FIG. 3 illustrates data processing operations according to an exemplary embodiment of the present invention;

FIG. 4 is a flowchart of a procedure for assigning a “log” attribute to a data table in a DBMS according to an exemplary embodiment of the present invention; and

FIG. 5 is a flowchart of a method for data processing in a DBMS according to another exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention relate to a data processing method and system for a database management system. In one exemplary embodiment, during database creation, a “log” attribute and a “no log” attribute may be selectively assigned to a table (used as a unit of data). Later, when field values of the table are changed during transaction processing, log records therefor may be written or not written according to the “log” or “no log” attribute assigned to the corresponding field. Hence, the number of log records for transaction processing may be decreased, thereby reducing the number of disk input/output operations for logging and increasing the data processing speed in the DBMS.

A description is given below of an exemplary configuration and operation of a device with reference to the drawings. However, the configuration and operation thereof are not limited to or by the following description, and various changes and modifications are possible on the basis of the following description.

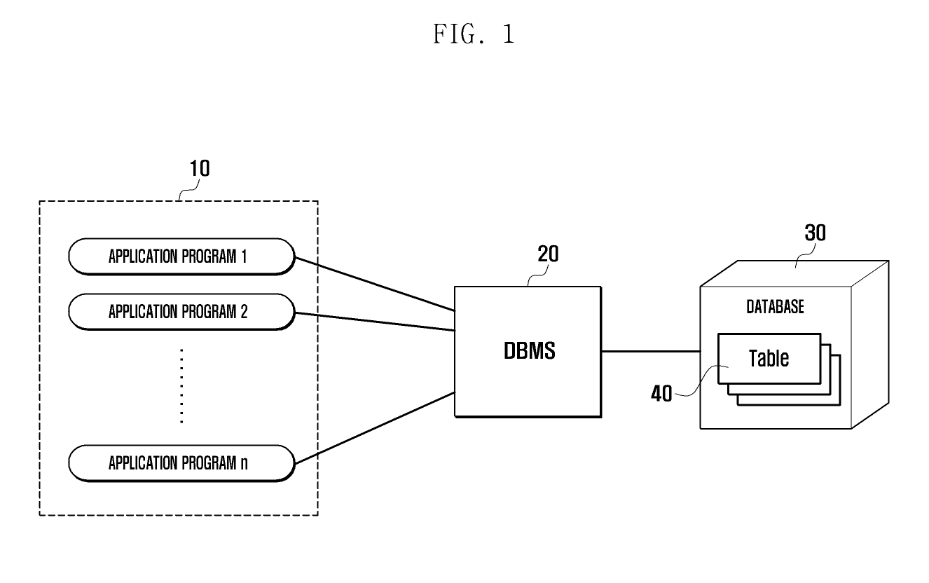

FIG. 1 illustrates a relationship between a DBMS and a database according to an exemplary embodiment of the present invention.

Referring to FIG. 1, the DBMS 20 is a software or program system that manages various data stored in the database 30 in a systematic fashion. The DBMS 20 is present between application programs 10 and the database 30, and manages the database 30 so that the database 30 can be shared by the application programs 10 according to user requirements. Such a DBMS is a system that is designed to address the problems of data redundancy and dependency in a file system.

Functions of the DBMS 20 may be classified into definition functions that define types and structures of data to be stored in the database 30 and schemes for utilizing data stored therein, manipulation functions that specify systematic data access operations such as retrieval, update, insertion and deletion, and control functions that specify correctness conditions for data in relation to integrity, security, authorization and concurrency control.

The DBMS 20 may be one of a hierarchical DBMS, a network DBMS, a relational DBMS, an object-oriented DBMS, and an object relational DBMS.

To use data stored in the database 30, the application programs 10 may access the database 30 via the DBMS 20.

A description is given of the relationship between the DBMS 20, the database 30 and the application programs 10 in connection with FIG. 1.

As described before, the database 30 is a storage area in which a set of data is stored. Data elements in the database 30 are kept distinct without duplication according to a specified rule and may be updated continuously. The DBMS 20 manages the database 30 so that data in the database 30 can be stored in an organized way and be changed in an orderly manner.

For example, in the case of online gaming, various information about users such as identifications of the users, and capabilities, levels, funds and locations of individual characters may be stored in the database 30. Whenever a user connects to the game site and plays the game, data elements of the user in the database 30 may be changed. Here, the application program 10 (a game program) does not directly change data elements in the database 30 but connects to the DBMS 20, which changes requested information elements in the database 30. That is, the DBMS 20 enables efficient management of a large data set for many online gamers.

The database 30 may be composed of one or more tables 40. That is, the DBMS 20 may manage data in the database 30 in units of tables. A table 40 may have columns and rows. For example, when project data is to be stored in a table 40, rows of the table 40 may correspond to individual projects of an organization, and columns thereof may contain data elements for project names, project numbers, responsible departments, start dates and the like. The DBMS 20 may manage data in the database 30 in units of tables having rows and columns. The database 30 may include multiple tables 40.

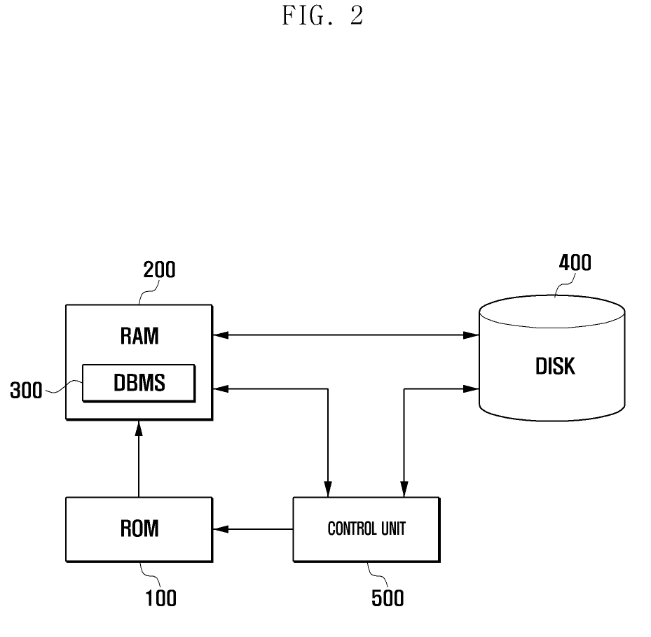

FIG. 2 is a block diagram of a device according to an exemplary embodiment of the present invention.

Referring to FIG. 2, the device includes a Read Only Memory (ROM) 100, a Random Access Memory (RAM) 200, a disk 400, and a control unit 500. Here, a DBMS 300 may be loaded in the RAM 200. Although not shown, the device may further include various components, such as a display unit for displaying screen data, an input unit for data manipulation, a communication interface for data communication, a battery for supplying power, and the like. These additional components are not illustrated or described further for sake of convenience.

The control unit 500 controls the overall state and operation of the device. More particularly, the control unit 500 may execute a program loaded in the RAM 200.

The ROM 100 stores system programs, such as an operating system and drivers, and related data under control of the control unit 500.

The RAM 200 temporarily stores data to be processed by the DBMS 300 under control of the control unit 500. The RAM 200 may temporarily store a program or data read from the ROM 100 or the disk 400.

The DBMS 300 loaded on the RAM 200 manages a database stored in the disk 400 in an orderly way according to a preset rule. The DBMS 300 may generate log records for various programs (for example, the operating system and applications) executed by the device and write the log records to the disk 400.

More particularly, the DBMS 300 may selectively assign a “log” or “no log” attribute to a column of a table. The DBMS 300 generates log records corresponding to transaction operations on data such as retrieval, insertion, deletion and update, and commits or rolls back the transaction using the log records. When a transaction is committed, the changes made to the data by the transaction are stored in the database. When a transaction is rolled back, the changes made to the data by the transaction are undone and the database is returned to the previous state.

In log-based transaction processing, the DBMS 300 may determine the “log” or “no log” attribute assigned to a column of the current table. When the “log” attribute is assigned to the column, the DBMS 300 generates log records for data manipulation operations on the column values and writes the log records. When the “no log” attribute is assigned to the column, the DBMS 300 does not generate log records for data manipulation operations on the column values and skips log recording. Handling of the “no log” attribute is described in more detail later.

The disk 400 stores various data generated by the device under control of the control unit 500. The disk 400 may store data from the RAM 200. The disk 400 may store and manage database data in the form of tables. The disk 400 may accumulate log records generated in the course of operating the device. That is, when a program such as the operating system or an application is executed, log records are generated in relation to the executed program. The generated log records may be accumulated and managed in the disk 400.

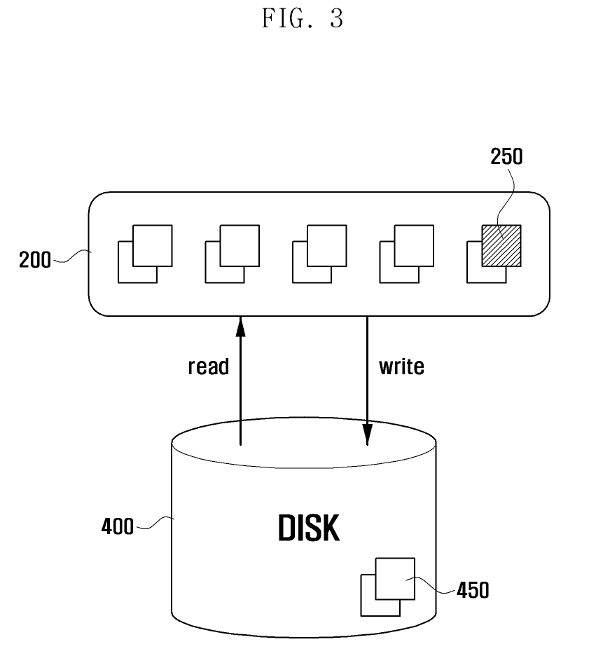

FIG. 3 illustrates data processing operations according to an exemplary embodiment of the present invention.

Referring to FIG. 3, to change original data 450 stored in the disk 400 (a nonvolatile storage), the original data 450 may be copied to in-memory data 250 in the RAM 200 (a volatile storage) (i.e., disk data is loaded on the RAM 200). Then, a change is made to the in-memory data 250. The changed in-memory data 250 may be temporarily stored in the RAM 200 and be written later to the original data 450 in the disk 400. Here, to distinguish data to be written to the disk from data not to be written to the disk, the DBMS 300 may use a log to record changes as described before.

The log is a history of changes made to data, and a log record is generated whenever corresponding data is changed. For example, the DBMS 300 generates log records corresponding to transaction operations on data such as retrieval, insertion, deletion and update, and commits or rolls back the transaction using the log records. Here, a transaction may correspond to a query including retrieval, insertion, deletion or update statements (data manipulation operations). When a data manipulation operation is performed, the DBMS 300 may write a corresponding log record to the disk 400. The data processing time may increase with an increasing number of log records to be written.

To adjust log recording, the “no log” attribute may be assigned to a transaction or to a database table. For example, the “no log” attribute may be assigned to a transaction labeled “temporary” that does not have to be rolled back so that log records for the transaction are not stored. Alternatively, the “no log” attribute may be assigned to a temporary table so that log records for the temporary table are not stored.

In a method of the related art, either the “log” attribute or the “no log” attribute may be assigned to a transaction or a table. That is, the “log” attribute and the “no log” attribute cannot be simultaneously assigned to a single table. Hence, when all log records are written for each log event like a data modification according to the “log” attribute, the data processing speed may be lowered with increasing number of log records. When all log records are not written for each log event like a data modification according to the “no log” attribute, even necessary log records may be not written.

In an exemplary implementation of the present invention, log records for log events are selectively written. Hence, the number of log records for transaction processing may be decreased, and the data processing speed in the DBMS 300 may be increased. To achieve this, during table creation, the “no log” attribute may be selectively assigned to a table. Later, when data values having the “no log” attribute are changed in response to log events during transaction processing, log records therefor need not be written. For example, a change or effect made on the RAM 200 (for example, in-memory data 250) is written to the disk 400. Later, when the change (for example, in-memory data 250) is removed from the RAM 200, the associated table is identified and log records for the change may be written or not written according to the “log” or “no log” attribute assigned to the corresponding column of the table.

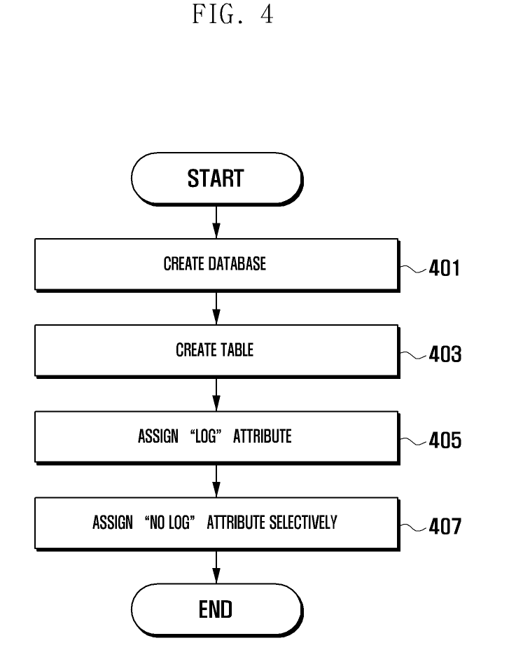

FIG. 4 is a flowchart of a procedure for assigning the “log” attribute to a data table in a DBMS according to an exemplary embodiment of the present invention.

Referring to FIG. 4, when the DBMS 300 receives a user request for database creation in step 401, the DBMS 300 creates a database table corresponding to the user request in step 403. That is, the DBMS 300 may create a database composed of at least one table according to a user request.

The DBMS 300 assigns the “log” attribute and the “no log” attribute to the table according to user selection in steps 405 and 407, respectively.

For example, the DBMS 300 may assign the “log” attribute to the table by default at step 405, and selectively assign the “no log” attribute to the table according to user selection at step 407. Here, the “no log” attribute may be assigned to a specific column of the table.

In an exemplary implementation, the device may provide an interface for assigning the “log” attribute to a specified database table. The interface may be displayed on a display unit (not shown), and the “log” attribute may be assigned to a table through an input unit (not shown). For selective skipping of log recording, the user may enter a command for assigning the “no log” attribute to a column of the table using the interface on the display unit. In that case, the default “log” attribute of the column may be switched to the “no log” attribute.

For example, when the user creates a database table using the interface, the user may selectively assign the “no log” attribute to a specific column of the table. Here, the interface is adapted to assign the “log” attribute to the table by default and assign the “no log” attribute according to user selection. The following statement illustrates selective assignment of the “no log” attribute during table creation:
<create table (id int, IsUpdated char(1) no log);>

Here, the “log” attribute is assigned to “id” and the “no log” attribute is assigned to “IsUpdated”.

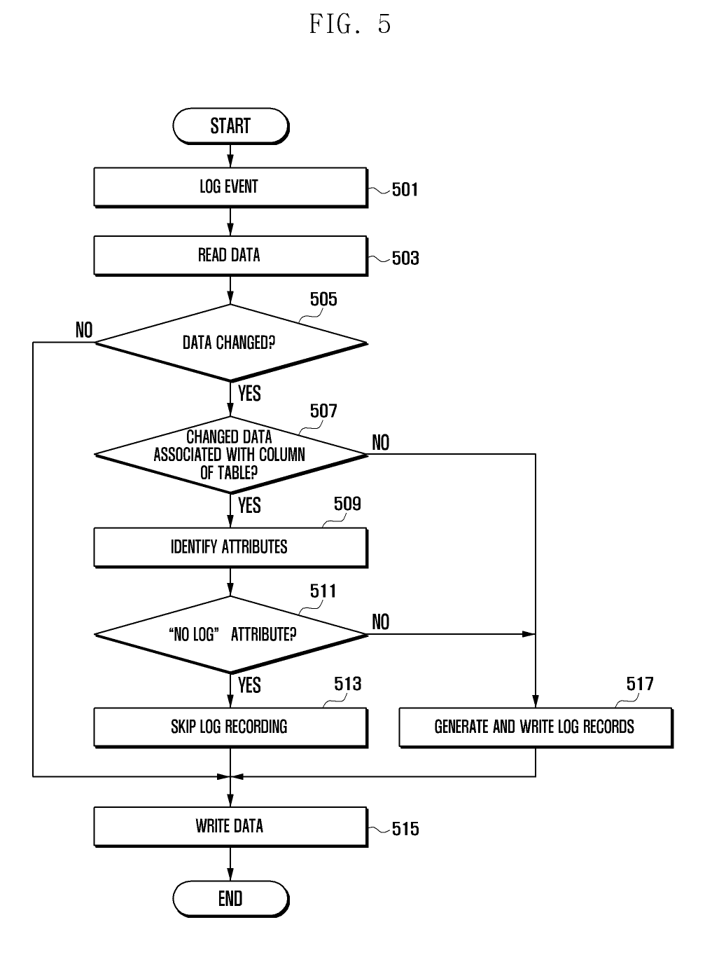

FIG. 5 is a flowchart of a method for data processing in a DBMS according to another exemplary embodiment of the present invention.

Referring to FIG. 5, the DBMS 300 detects a log event under control of the control unit 500 in step 501. The DBMS 300 reads a data item associated with the log event in step 503. For example, the DBMS 300 may read a data item associated with the log event from the disk 400 and load the read data item in the RAM 200.

Thereafter, the DBMS 300 determines whether the data item is changed in step 505. For example, data manipulation operations such as retrieval, insertion, deletion and update may change the data item. These data manipulation operations may belong to a specific transaction.

When it is determined in step 505 that the data item is not changed, the DBMS 300 may write the data item in step 515. This case may correspond to the end of the log event (i.e., end of transaction) without data change. Here, the original data item in the disk 400 may be preserved.

On the other hand, when it is determined in step 505 that the data item is changed, the DBMS 300 determines whether the changed data item is associated with a specific column of a given data table in step 507.

When it is determined in step 507 that the changed data item is not associated with a specific column of a given data table, the DBMS 300 generates log records for the change and writes the log records to the disk 400 in step 517. Later, when the transaction ends, the DBMS 300 writes the changed data item to the disk 400 in step 515.

On the other hand, when it is determined in step 507 that the changed data item is associated with a specific column of a given data table, the DBMS 300 identifies attributes assigned to the column of the table in step 509 and determines whether the attributes of the column include the “no log” attribute in step 511.

When it is determined in step 511 that the attributes of the column include the “log” attribute, the DBMS 300 generates log records for the change and writes the log records to the disk 400 in step 517. Later, when the transaction ends, the DBMS 300 writes the changed data item in the RAM 200 to the disk 400 in step 515.

On the other hand, when it is determined in step 511 that the attributes of the column include the “no log” attribute, the DBMS 300 does not generate log records for the change to thereby skip log recording in step 513. Later, when the transaction ends, the DBMS 300 writes the changed data item on the RAM 200 to the disk 400 in step 515.

As described above in connection with FIG. 5, in exemplary embodiments of the present invention, when a query containing data retrieval, insertion, deletion or update operations is processed, generation and writing of log records are selectively performed according to the “no log” attribute assigned to a specific column of a given data table. That is, when a transaction composed of data retrieval, insertion, deletion or update operations is processed, the “log” or “no log” attribute assigned to each column of the current table is identified, and log recording may be performed for a column having the “log” attribute and log recording may not be performed for a column having the “no log” attribute. Hence, the number of log records may be decreased, and the data processing speed and the recovery speed in the DBMS 300 may be increased.

According to exemplary embodiments of the present invention, the data processing method for a database management system may be implemented as computer programs and may be stored in various computer readable storage media. The computer readable storage media may store program instructions, data files, data structures and combinations thereof. The program instructions may include instructions developed specifically for exemplary embodiments of the present invention and existing general-purpose instructions.

The computer readable storage media may include magnetic media such as a hard disk and floppy disk, optical media such as a CD-ROM and DVD, magneto-optical media such as a floptical disk, and memory devices such as a ROM and RAM. The program instructions may include machine codes produced by compilers and high-level language codes executable through interpreters.

The description of the various embodiments is to be construed as exemplary only and does not describe every possible instance of the invention. Therefore, it should be understood that various changes may be made and equivalents may be substituted for elements of the invention.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for data processing in a database management system, the method comprising:
identifying one or more attributes assigned to a column of a data table associated with a data item changed during processing of a transaction;
writing, when the one or more attributes of the column include a “log” attribute, log records for the transaction to a disk; and
skipping, when the one or more attributes of the column include a “no log” attribute, log recording for the transaction.

2. The method of claim 1, further comprising selectively assigning the “log” attribute or the “no log” attribute to each column of the data table during creation of a database.

3. The method of claim 2, wherein the identifying of the one or more attributes assigned to the column of the data table comprises:
reading, upon detection of a log event, a data item associated with the log event from the disk; and
examining the one or more attributes assigned to the column of the data table related to the read data item during processing of the transaction.

4. The method of claim 3, wherein the identifying of the one or more attributes assigned to the column of the data table comprises:
determining whether the data item is changed; and
determining, when the data item is changed, whether the changed data item is related to the column of the data table.

5. The method of claim 4, wherein the determining of whether the data item is changed comprises determining whether the data item is a result of at least one of a retrieval, an insertion, a deletion, and an update operation.

6. The method of claim 4, wherein the identifying of the one or more attributes assigned to the column of the data table further comprises:
writing, when the changed data item is not related to the column of the data table, log records for the data change to the disk; and
examining, when the changed data item is related to the column of the data table, the one or more attributes assigned to the column.

7. The method of claim 6, wherein the examining of the one or more attributes assigned to the column comprises:
determining whether the one or more attributes of the column include the “log” attribute or the “no log” attribute;
writing, when the one or more attributes of the column include the “log” attribute, log records for the data change to the disk; and
skipping, when the one or more attributes of the column include the “no log” attribute, log recording for the data change.

8. The method of claim 6, further comprising writing, when the transaction ends after log record writing, the changed data item to the disk.

9. The method of claim 5, wherein, when a transaction composed of at least one of a retrieval, an insertion, a deletion, and an update operation, log records for data items of a column of the data table having the “log” attribute are written and log recording for data items of a column having the “no log” attribute is skipped.

10. A data processing system comprising:
a Random Access Memory (RAM) for temporarily storing various programs and related data;
a disk for storing data processed or to be processed, and for storing transaction logs; and
a Database Management System (DBMS) for selectively assigning a “log” attribute or a “no log” attribute to a column of a data table, and for performing or for skipping log recording according to the “log” attribute or the “no log” attribute assigned to a column of a given data table during transaction processing.

11. The data processing system of claim 10, wherein, when a transaction composed of at least one of a retrieval, an insertion, a deletion and an update operations is processed, the DBMS writes log records for data items of a column of a data table having the “log” attribute to the disk and skips log recording for data items of a column of the data table having the “no log” attribute.

12. The data processing system of claim 10, wherein the DBMS identifies one or more attributes assigned to a column of a data table associated with a data item changed during processing of a transaction, writes, when the one or more attributes of the column include the “log” attribute, log records for the transaction to a disk, and skips, when the one or more attributes of the column include the “no log” attribute, log recording for the transaction.

13. The data processing system of claim 12, wherein the DBMS selectively assigns the “log” attribute or the “no log” attribute to each column of the data table during creation of a database.

14. The data processing system of claim 13, wherein the DBMS reads, upon detection of a log event, a data item associated with the log event from the disk, and examines the one or more attributes assigned to the column of the data table related to the read data item during processing of the transaction.

15. The data processing system of claim 14, wherein the DBMS determines whether the data item is changed, and determines, when the data item is changed, whether the changed data item is related to the column of the data table.

16. The data processing system of claim 15, wherein the DBMS determines whether the data item is changed by determining whether the data item is a result of at least one of a retrieval, an insertion, a deletion, and an update operation.

17. The data processing system of claim 15, wherein the DBMS writes, when the changed data item is not related to the column of the data table, log records for the data change to the disk, and examines, when the changed data item is related to the column of the data table, the one or more attributes assigned to the column.

18. The data processing system of claim 17, wherein the DBMS determines whether the one or more attributes of the column include the “log” attribute or the “no log” attribute, writes, when the one or more attributes of the column include the “log” attribute, log records for the data change to the disk, and skips, when the one or more attributes of the column include the “no log” attribute, log recording for the data change.

19. The data processing system of claim 17, wherein the DBMS writes, when the transaction ends after log record writing, the changed data item to the disk.

20. The data processing system of claim 16, wherein, when a transaction composed of at least one of a retrieval, an insertion, a deletion, and an update operation, the DBMS writes log records for data items of a column of the data table having the “log” attribute and skips log recording for data items of a column having the “no log” attribute.
